(19) United States
(12) Patent Application Publication
(10) Pub. No.: US 2005/0249311 A1
(43) Pub. Date: Nov. 10, 2005

(54) Modulation schemes for reduced power amplifier backoff

(76) Inventors: Bryan S. Nollett, Champaign, IL (US); John P. Oliver, Chicago, IL (US); Douglas L. Jones, Champaign, IL (US)

Correspondence Address: MOTOROLA INC, 600 NORTH US HIGHWAY 45, ROOM AS437, LIBERTYVILLE, IL, 60048-5343, US

(21) Appl. No.: 10/841,657

(22) Filed: May 7, 2004

(51) Int. Cl. H04L 25/49

(52) U.S. Cl. 375/298; 375/146

(57) ABSTRACT

A method in a radio transmitter, the method including generating indices, for example, with an index generator (132), encoding information by selecting different subsets of correlation-separable signals, for example, by multiplexing orthogonal spreading codes with indices input to a multiplexor (142), encoding information by modulating at least some of the indices with a modulator (134), and combining the information encoded by selecting the different subsets of correlation-separable signals with the information encoded by modulating at least some of the indices.

### FIELD OF THE DISCLOSURE

The present disclosure relates generally to power amplifiers and more particularly to power amplifier modulation schemes suitable for relatively high data rate communications applications, for example, in CDMA cellular communication devices, and methods.

### BACKGROUND OF THE DISCLOSURE

In some applications, radio frequency (RF) power amplifiers must produce increased transmit power without distortion to maintain acceptable levels of signal distortion and adjacent channel interference. For example, one technique used for achieving higher data rates in CDMA communications systems is the simultaneous transmission of data on multiple orthogonal code channels, sometimes referred to as multicode CDMA. Multicode CDMA modulation increases the magnitude of envelope variations above the average power. The peak-to-average ratio (PAR) of the modulation is one measure of such variations above the mean. This increased variation however requires increased “backoff” of average amplifier power relative to maximum power. Generally, amplifiers having higher peak power output transmitting signals with larger backoff are less efficient at developing a given average power than amplifiers having lower peak power output transmitting signals with smaller backoff.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is a schematic diagram of an exemplary transmitter.

FIG. 2 is a prior art 4-bit modulator architecture.

FIG. 3 is an exemplary 4-bit modulator architecture.

FIG. 4 is an exemplary 3-bit modulator architecture.

FIG. 5 is an exemplary 5-bit modulator architecture.

### DETAILED DESCRIPTION

The disclosure pertains generally to radio and other wireless transmitters, for example, transmitters used in wireless communications devices including cellular telephones, wireless-enabled computing devices, among a variety of other fixed and mobile radio transmitter applications.

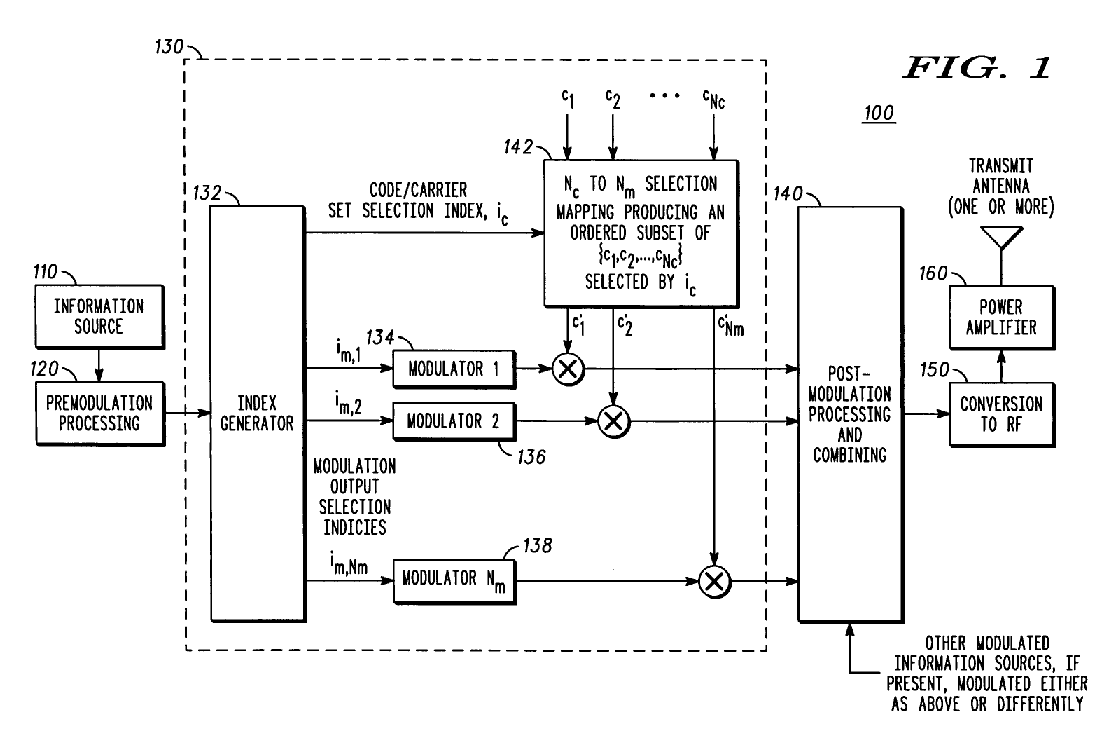

In FIG. 1, the exemplary wireless transmitter architecture 100 comprises generally an information source 110, for example, voice signals, video streams, computer data files, etc., having an output coupled to a pre-modulation entity 120, which may include, for example, analog-to-digital conversion for some signals, channel coding and source compression, etc. An output of the pre-modulation processing entity is coupled to a modulation or encoding entity 130, the operation of which is discussed further below. The encoding entity 130 outputs are coupled to a post modulation processing and combining entity 140 having an output coupled to a RF conversion entity 150. An output of the RF conversion entity is coupled to a power amplifier 160 and antenna.

The architecture of FIG. 1 is only exemplary and not intended to limit the disclosure, as other embodiments may include additional entities and/or may not include one or more of the entities illustrated in FIG. 1. For example, in other embodiments and more generally, additional encoding entities or modulated information sources include outputs coupled to the post-modulation entity 140.

In FIG. 1, the encoding entity 130 includes an index generator 132 that outputs indices, for example, in the form of binary information or bits. The index generator 132 generates outputs based on or corresponding to inputs from the pre-modulation processor. In one exemplary embodiment, the index generator produces indices corresponding to symbols input by the pre-modulation or other entity.

In one embodiment, the encoding entity includes a modulator that modulates at least some of the indices output by the index generator. In FIG. 1, for example, N_{M} modulators 134, 136, 138 . . . are coupled to the exemplary output of the index generator 132. The modulators may be of any type including, QPSK, BPSK among other linear or non-linear modulation formats. At least one index i_{m,Nm} is input to each modulator N_{M}. In some embodiments, multiple indices are input to the modulator. Generally, information, for example, the input indices, are encoded or modulated pursuant to the format of the encoding entity, and the resulting signals are input to the post modulation processing and combining entity 140. The modulation occurs generally over corresponding modulation intervals, as is known generally by those having ordinary skill in the art.

In some embodiments, information is encoded by selecting different subsets of a larger set of correlation-separable signals. Exemplary correlation-separable signals or variables include but are not limited to orthogonal spreading codes, orthogonal sinusoidal carriers, and pseudo-orthogonal signals, among other signals. Pseudo-orthogonal signals do not satisfy strict statistical orthogonality definitions, which are based on correlation properties, but may nevertheless be suitable or useful for some embodiments disclosed herein. And in some embodiments, at least one of the different subsets of correlation separable variables includes at least two correlation-separable signals.

In one embodiment, the selection or choice of the subsets of correlation-separable signals is made by indices. In FIG. 1, for example, one or more of the indices generated by the index generator 132 select or selects correlation-separable signals, C₁, C₂, . . . C_{Nc}, at a selection entity 142, for example, at a multiplexor. In other embodiments, the selection or choice of correlation-separable signals may be made by other means.

Generally, the selection of correlation-separable variables occurs over corresponding selection intervals, wherein the time varying choice or selection of different subsets is indicative of some information.

In some embodiments, the information modulated or encoded by the modulator is combined with the different subsets of correlation-separable variables. In FIG. 1, for example, the selected correlation-separable variables C₁′, C₂′, . . . C_{Nc}′ are multiplied with the outputs of corresponding modulators 134, 136 and 138, respectively, before the combined signals are input to the post-modulation processing and combining entity 140. In embodiments where the selected correlation-separable signals are combined with modulator outputs and the number of selected correlation-separable signals is less than the number of modulators, some of the modulator outputs are combined with or multiplied by zero.

In one embodiment where the different selected signal subsets are combined with the modulated signals, the selection intervals are integer multiples of the modulation intervals, including, for example, a one-to-one ratio. In some embodiments, the modulating and selecting occurs at corresponding intervals having synchronized or aligned boundaries. And in still other embodiments, the modulating and selecting occur at a common rate, which may or may not be aligned. As suggested, the structure of the information source through the generalized modulator 130 may be repeated in parallel and input to the post-modulation processing and combining block. In this case, the modulation symbol period and set selection period in the different modulators need not be identical. Other structures of information source through the modulator also may be used in parallel and input to the post-modulation processing and combining block. The modulator may be used in combination with other modulators, which may have different modulation or symbol periods.

In one embodiment, amplifier envelope excursions may be controlled by encoding at least some of the information in a choice of different correlation-separable signals from a set of correlation-separable signals. In one embodiment, for example, the backoff is decreased by combining the modulator output and the choice of correlation-separable signals.

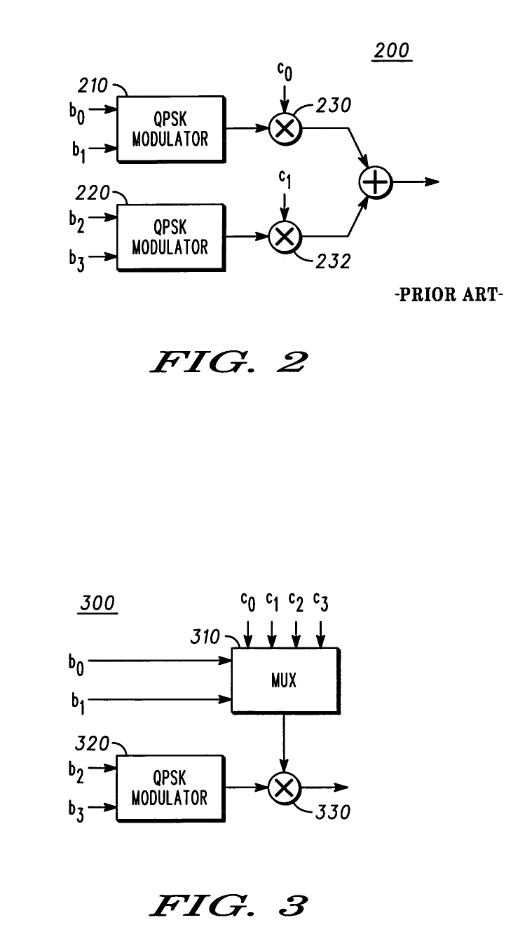

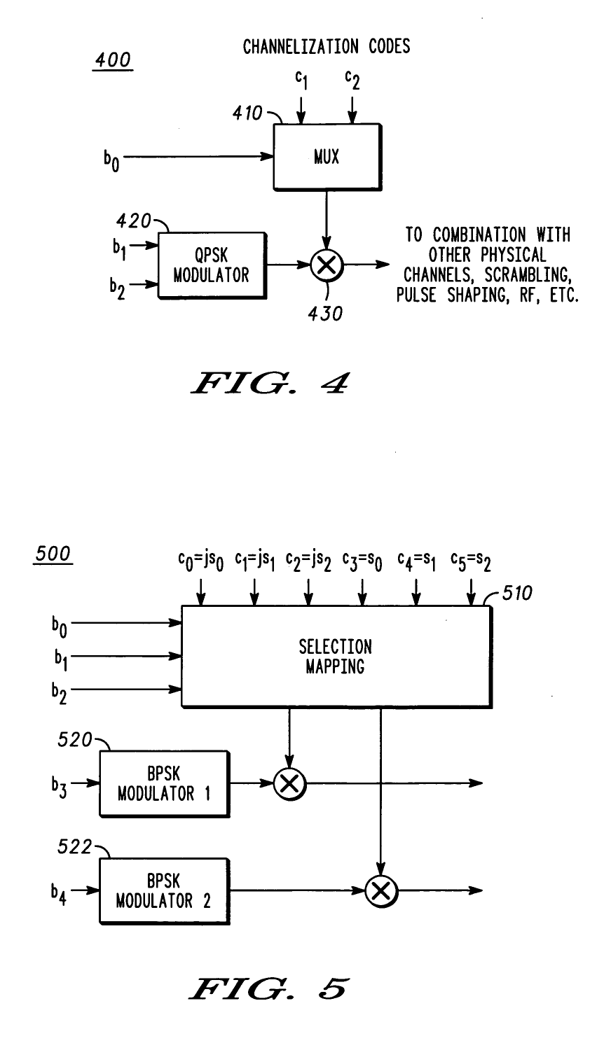

In FIG. 2, the prior art modulation system 200 includes first and second quaternary phase shift key (QPSK) modulators 210 and 220. The first modulator 210 modulates first and second bits b₀ and b₁ and the second modulator 220 modulates third and fourth bits b₂ and b₃. In FIG. 4, the modulated outputs are multiplied with corresponding first and second correlation-separable signals, for example, orthogonal spreading codes, C₀ and C₁, at multipliers 230 and 232, respectively. The multiplied signal is subsequently summed at block 234, and then subject to further processing prior to radio transmission. The prior art modulation architecture thus transmits the encoded information using two orthogonal spreading codes C₀ and C₁. The transmitter amplifier required to implement the architecture of FIG. 2 has a characteristic peak power, back off and average power.

FIG. 3 illustrates an exemplary encoding architecture 300 according to the instant disclosure comprising a selection entity, in the exemplary form of a multiplexor, 310 having as inputs first and second bit b₀ and b₁ of a bit stream. The first and second bits b₀ and b₁, which have four possible states, select one of four different correlation-separable signals C₀, C₁, C₂ and C₃ during a corresponding bit interval, wherein the correlation-separable signals selected vary from interval to interval, as discussed more fully above. The architecture of FIG. 3 also includes a modulator 320, the exemplary form of which is a QPSK format, having as its input third and fourth bits b₂ and b₃. The output of modulator 320 is combined with the selected correlation-separable variable by multiplier 330 as discussed above.

In comparison to FIG. 2, the amplifier required to implement the architecture of FIG. 3 will generally be smaller and more efficient than the amplifier of FIG. 2. For example, the amplifier required to implement the architecture of FIG. 3 will have a lower peak power and a relatively decreased backoff than the amplifier required to implement the embodiment of FIG. 2. While the amplifier required to implement the architecture of FIG. 3 requires an additional correlation-separable signal, and may have a slightly greater average power, it will operate in a more efficient amplification range.

FIG. 4 illustrates an exemplary encoding architecture 400 according to the instant disclosure comprising a selection entity, in the exemplary form of a multiplexor, 410 having as inputs a first bit b₀ of a bit stream. The first bit b₀, which has two possible states, selects one of two different correlation-separable signals or channelization codes C₀ and C₁ during a corresponding interval, wherein the correlation-separable signal selected varies from interval to interval, as discussed above. The architecture of FIG. 4 also includes a modulator 420, the exemplary form of which has a QPSK format, having as its input second and third bits b₁ and b₂. The output of modulator 420 is combined with the selected correlation-separable variable by multiplier 430, wherein the output of the multiplier may be further processed as discussed above.

FIG. 5 illustrates an exemplary encoding architecture 500 according to the instant disclosure comprising a selection entity 510 having as inputs a three bit b₀, b₁, and b₂. In the encoding architecture of FIG. 5, the set of correlation-separable signals input to the selection entity 510 include real-valued orthogonal spreading codes s₀, s₁, and s₂ as well as complex-valued orthogonal phase-rotated versions of the codes, js₀, js₁, and js₂. In FIG. 5, under control of the input bits b₀, b₁, and b₂, the selection mapping produces one of the three orthogonal signals from the set containing js₀, js₁, and js₂ for combination with the output of modulator 520, and one of the three orthogonal signals s₀, s₁, and s₂ for combination with the output of modulator 522. The exemplary modulators 520 and 522 employ binary phase keying (BPSK) and produce outputs according to their respective bit inputs b₃ and b₄. A multiplier combines the output of modulator 520 with the orthogonal spreading code selected for modulator 520 as discussed above. Similarly, another multiplier combines the output of modulator 522 with its selected orthogonal code.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

1. A method in a radio transmitter, the method comprising:
generating indices;
encoding information by selecting different subsets of correlation-separable signals;
encoding information by modulating at least some of the indices;
combining the information encoded by selecting the different subsets of correlation-separable signals with the information encoded by modulating at least some of the indices.

2. The method of claim 1, transmitting the encoded information after combining.

3. The method of claim 1,
modulating the indices over modulation intervals,
selecting different subsets of correlation-separable signals over intervals that are multiples of the modulation intervals.

4. The method of claim 1,
modulating the indices and selecting different subsets of correlation-separable signals at corresponding intervals having aligned boundaries.

5. The method of claim 1,
modulating the indices and selecting different subsets of correlation-separable signals at a common rate.

6. The method of claim 1,
the radio transmitter having multiple modulator outputs,
selecting different subsets of correlation-separable signals wherein each of the different subsets has a size between 0 and the number of modulator outputs.

7. The method of claim 1,
selecting different subsets of correlation-separable signals includes selecting different subsets of orthogonal spreading codes.

8. The method of claim 1,
selecting different subsets of correlation-separable signals includes selecting different subsets of orthogonal sinusoidal carriers.

9. The method of claim 1,
selecting different subsets of correlation-separable signals includes selecting different subsets of pseudo-orthogonal signals.

10. The method of claim 1, selecting the different subsets of correlation-separable signals using at least some of the indices generated.

11. A method in a radio transmitter having an amplifier, the method comprising:
encoding information by selecting different subsets of correlation-separable signals from a set of correlation-separable signals,
at least one of the different subsets of correlation-separable signals includes at least two correlation-separable signals;
transmitting the encoded information.

12. The method of claim 11, encoding information with a modulator;
multiplying the information encoded with the modulator with the information encoded by selecting the different subsets of correlation-separable signals;
transmitting the encoded information after multiplying.

13. The method of claim 12,
modulating over modulation intervals,
selecting different subsets of correlation-separable signals over intervals that are integer multiples of the modulation intervals.

14. The method of claim 12,
modulating and selecting at corresponding intervals having aligned boundaries.

15. The method of claim 12,
modulating and selecting at a common rate.

16. The method of claim 11,
generating indices;
selecting the different subsets of correlation-separable signals with at least some of the indices generated.

17. The method of claim 16,
modulating at least some of the indices generated.

18. The method of claim 11,
selecting different subsets of correlation-separable signals includes selecting different subsets of orthogonal spreading codes.

19. The method of claim 11,
selecting different subsets of correlation-separable signals includes selecting different subsets of orthogonal sinusoidal carriers.

20. The method of claim 11,
selecting different subsets of correlation-separable signals includes selecting different subsets of pseudo-orthogonal signals.

21. A method in a radio transmitter having an amplifier, the method comprising:
encoding information;
transmitting the encoded information;
controlling amplifier envelope excursions by encoding at least some of the information in a choice of different correlation-separable signals from a set of correlation-separable signals,
at least one of the different subsets includes at least two correlation-separable signals.

22. The method of claim 21, encoding at least some of the information by modulation.

23. The method of claim 22,
multiplying the information encoded by modulation with the information encoded in the choice of correlation-separable signals from the set of correlation-separable signals,
transmitting the encoded information after multiplying.
